(19) United States
(12) Patent Application Publication
(10) Pub. No.: US 2005/0285882 A1
(43) Pub. Date: Dec. 29, 2005

(54) Display device and television device

(75) Inventor: Kenji Shino, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/152,176

(22) Filed: Jun. 15, 2005

(30) Foreign Application Priority Data
Jun. 29, 2004 (JP) 2004-191823

(51) Int. Cl. G09G 5/10

(52) U.S. Cl. 345/690

(57) ABSTRACT

Reduction of a display period due to blank shift of a shift register is eliminated. To achieve this, a driving device of a display panel comprises a scanning driver of sequentially selecting scanning wirings by sequentially transferring a selection signal by using the shift register, and a controller of giving the selection signal to the shift register. The controller gives the shift data for scanning (n+1)-th field to the shift register while the shift register is transferring the shift data for scanning n-th field.

### BACKGROUND OF THE INVENTION

1. Field of the Invention

The present invention relates to a driving device of a display device. More specifically, the present invention relates to the display device which transfers shift data to the shift register of the driving device at predetermined timing and outputs a selection signal to a scanning wiring based on the shift data, and the television device which uses the relevant display device.

2. Related Background Art

Japanese Examined Patent Application No. H07-21700 (hereinafter called the patent document 1) discloses that, in a case where it intends to display on the matrix display device the screen of which the number of lines is less than the number of display lines, the length of a blank (idle) shift period of a shift register or the frequency of a blank shift clock can be changed.

That is, conventionally, the shift register is blank-shifted (or idly shifted) as much as is desired to appropriately skip non-display lines. For this reason, a valid display period (valid luminescence period) decreases as much as the length equivalent to the blank shift period.

In this connection, to shorten the blank shift period, it is possible to increase the frequency of the blank shift clock as described in the patent document 1. However, in such a case, it is necessary to cause the shift register to operate at high speed, that is, it is necessary to provide the shift register which can correspond to a high-speed operation, whereby a problem that circuit design becomes difficult and complicated occurs.

### SUMMARY OF THE INVENTION

The present invention has been completed in consideration of such an actual condition, and an object thereof is to provide a technique for eliminating reduction of a display period due to blank shift on a shift register.

More specifically, the present invention aims to provide a display device which is equipped with a display panel having plural scanning wirings, plural modulation wirings and plural matrix-arranged display elements, and a driving device for driving the display panel, wherein
the driving device comprises a scanning driver adapted to output selection signals with sequential addressing to each scanning line of the scanning wirings, and a controller adapted to control the scanning driver,
the scanning driver comprises a shift register adapted to sequentially transfer shift data input from the controller to registers,
the selection signals are output based on the shift data,
before transfer of first shift data by which the shift register scans a first field ends, the controller controls to transfer second shift data by which the shift register scans a second field subsequent to the first field to the shift register, and
after the transfer of the first shift data to the register of selecting the last scanning wiring in the first field ended, the controller controls to transfer the second shift data to the register of selecting the headmost scanning wiring in the second field.

### BRIEF DESCRIPTION OF THE DRAWINGS

FIG. 1 is a view including a plane and a side views indicating the structure of an image display device;

FIG. 2 is a view showing the structure of scan drivers;

FIG. 3 is a timing chart showing a timing of inputting shift data to shift registers; and

FIG. 4 is a block diagram showing the structure of a television device.

### DETAILED DESCRIPTION OF THE PREFERRED EMBODIMENTS

The present invention can be applied to various image display devices such as a liquid crystal display device, a plasma display device, a field emission display device, an EL (electroluminescence) display device and the like. Particularly, the present invention is preferably applied to an image display device of increasing the output luminance in proportion to a voltage applying time such as the plasma display device and the field emission display device. Concretely, the present invention is preferably applied to an image display panel having plural scan wirings and modulation wirings and plural display elements arranged in a matrix (here, a display element is a liquid crystal pixel portion, a pixel portion including a plasma generation portion and luminous material, a pixel portion including an electron emission element and luminous material, an EL pixel portion and a pixel portion including a micromirror), wherein the luminance of each of pixels is modulated in accordance with video data by the multiplexing drive of the display element.

Hereinafter, the preferable embodiment of the present invention will be explained in detail by giving an example of the image display device which has a display panel, where pixel portions (display elements) structured by using surface conduction electron emitters (hereinafter, called an SCE elements) and the luminous material (for example, fluorescent material) of emitting light upon receiving electrons emitted from the SCE elements are arranged in matrix.

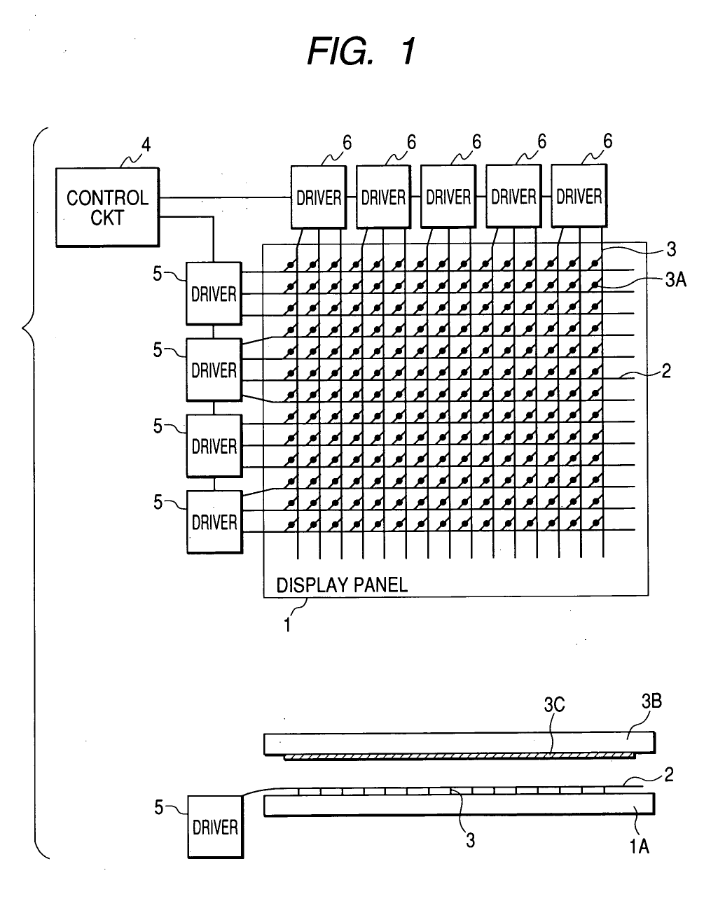

FIG. 1 shows a plane view and a side view of the image display device according to the embodiment of the present invention. The image display device has a display panel (matrix panel) 1, drivers (scan drivers) 5, drivers (modulation drivers) 6 and a control circuit 4. The display panel 1 has plural scan wirings 2 and plural modulation wirings 3 arranged on a rear panel 1A in the shape of lattice, plural SCE elements 3A connected to intersection points of the scan wirings 2 and the modulation wirings 3 and a face plate 3B having fluorescent material 3C.

In the above structure, when a predetermined voltage (for example, several tens voltage) is applied between the scan wirings 2 and the modulation wirings 3, electrons are emitted from the SCE elements 3A. The emitted electrons are accelerated toward the face plate 3B, to which the high voltage of several kilovolts (kV) to several tens kilovolts (kV) is applied. Due to the collision of the electrons with the face plate, the fluorescent material 3C emits light. The luminance of the light emitted from the fluorescent material 3C is almost proportional to the time to collide the electrons with the fluorescent material 3C.

In case of displaying an image, the control circuit 4 controls the scan drivers 5 and the modulation drivers 6 on the basis of a video signal to be input. More particularly, the scan drivers 5 output selection signals to the selected scan wirings 2 to be driven and output non-selection signals (for example, ground potential) to the scan wirings 2 which are not selected. The modulation drivers 6 output modulation signals corresponding to an image for one line to the plural modulation wirings 3 in parallel. Thereby the SCE elements for one line are driven. Then, the scan wirings 2 to be selected are successively scanned in linear order in the scan drivers 5. Thereby, an image for one field is displayed.

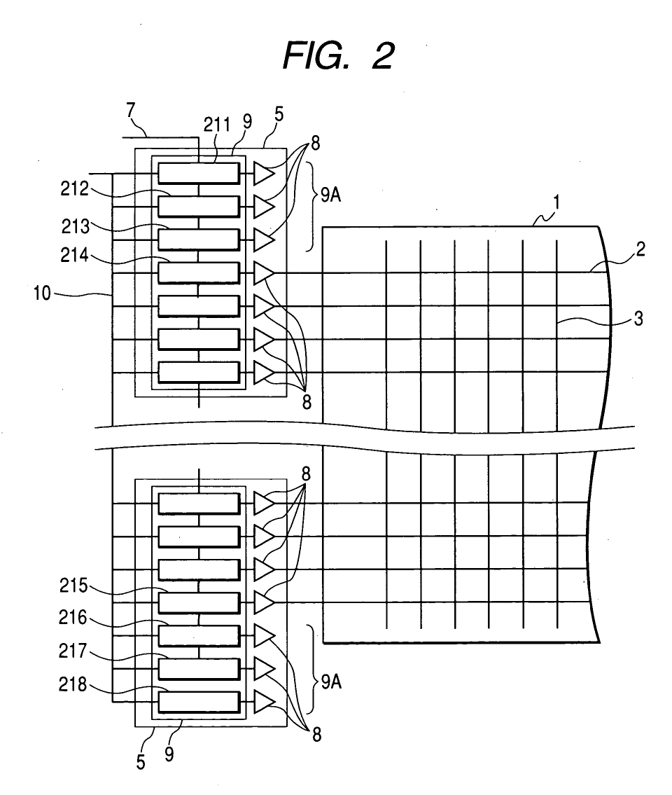

In order to realize such a selection operation, such shift registers 9 shown in FIG. 2 are respectively used in the scan drivers 5. When the control circuit 4 supplies shift data to the shift registers 9 through a data line 7, an output from the most upper register 211 among m (m is a positive integer) pieces of registers 211, 212, 213, 214, 215, 216, 217, 218 and the like structuring the shift registers 9 becomes an ON state, and the selection signals are supplied to the scan wirings 2 through output drivers 8 provided for the respective registers. Then, the shift data is successively shifted to the lower registers every time a shift clock is input through a clock line 10, and the scan wirings 2, to which the selection signals are supplied, are successively switched. It should be noted that the shift register 9 and the output drivers 8 can be structured in an integrated circuit (IC) by one chip as the scan driver 5.

Here, a scanning period of transmitting the shift data, which was input from the control circuit 4, from the most upper first register to the lowest m-th register is assumed as one field.

Incidentally, there is a case that the total number of lines of the scan wirings 2 is not always equivalent to the total number of outputs from the scan drivers 5. For example, a case of using an IC, which is designed for the resolution in the digital broadcasting format of performing the successive scan for the number of effective pixels: horizontal 1280×vertical 720 (hereinafter, described as 720P), for the display of the resolution in the digital broadcasting format of performing the successive scan for the number of effective pixels: horizontal 1980×vertical 1080 (hereinafter, described as 1080P) corresponds to the above case.

In case of the resolution of 720P, the total number of lines of the scan wirings 2 is 720 lines. For example, if an IC of which the number of outputs is equivalent to 144 lines is used, the scan drivers 5 for driving the scan wirings 2, of which the total number of lines is just 720 lines, can be structured by combining five pieces of the IC's. However, in case of utilizing this IC for a device having the resolution of 1080P, if eight pieces of the IC's are used, the number of outputs of the scan drivers 5 becomes 1152 (=8×144). As a result, the number of outputs equivalent to 72 lines are remained for the total number of 1080 lines of the scan wirings 2.

Generally, since a development period of a half year to one year and a large amount of development costs are required in the development of an IC, the IC can not be easily restructured. Therefore, difference between the total number of lines of the scan wirings 2 and the total number of outputs from the scan drivers 5 has to be sometimes permitted. In this case, the above difference is adjusted by arranging unusable portions (hereinafter, called surplus registers 9A) of the scan drivers 5 on upper and lower positions of the display panel 1 as shown in FIG. 2. The surplus registers 9A are treated as unusable output lines which are not connected to the scan wirings 2.

However, if the surplus registers 9A are provided, the following problem occurs.

The shift registers 9 are composed of the plural registers 211, 212, 213, 214, 215, 216, 217, 218 and the like and structured that the shift data is successively transmitted to the registers from the most upper register. Therefore, a process of shifting data is also executed for the surplus registers 9A which are not connected to the scan wirings 2 similar to the registers which are connected to the scan wirings 2. This situation corresponds to so-called “blank shift”. During a period of executing the blank shift, since the SCE elements are not driven, the corresponded image display period is decreased.

For example, in case of using the scan drivers 5, of which the number of outputs is equivalent to 1152 lines, for the scan wirings 2, of which the number of lines is equivalent to 1080 lines, the 72 surplus registers 9A are left. When these surplus resisters 9A are assigned into the upper and lower portions in the screen, the 36 surplus registers 9A, which are equal to half of 72 pieces, are arranged in the upper portion in the screen. If the blank shifts are executed with respect to the 36 surplus registers 9A by using a shift clock of 67 kHz (14.9 μsec) being one horizontal period, the time of about 0.54 msec=(36×14.9)μsec is required. This time corresponds to 3% of a period of one field (16.7 msec). In the image display device using the SCE elements, since the output luminance is almost proportional to a period of displaying an image, if the unavailable time such as the above 3% exists, it is not preferable from a viewpoint of the improvement in luminance.

In order to improve a problem such as the deterioration in luminance, a method of shortening a period of the blank shift by increasing the frequency of the shift clock at portions of the surplus registers 9A has been proposed. However, this method has the following problem.

Generally, in the resolution of 1080P, the frequency of the shift clock is about 67 kHz. As against this fact, in a case that the blank shifts are intended to be processed with respect to the 36 surplus registers 9A under the time of, for example, 100 μsec, an operation by the shift clock of which the frequency is about 400 kHz is required. If the operation frequency of the shift clock more increases, a design of the IC becomes more difficult. Especially, in the structure as seen in the scan drivers 5 where the clock signal is input in many IC's in parallel, the difficulty in design of the IC more increases.

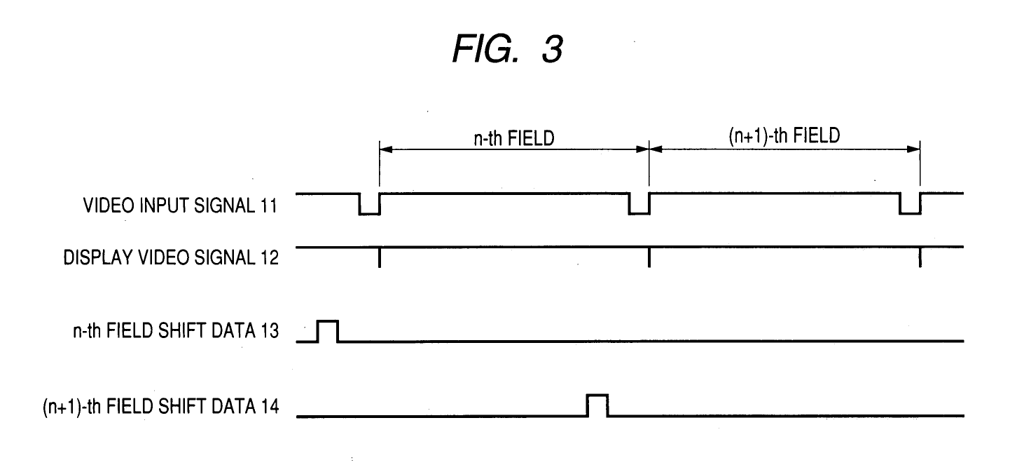

In the present embodiment, the decrease of a display period due to the blank shift is avoided by adjusting a timing of giving shift data to the shift registers 9 without changing the frequency of the shift clock, in consideration of the above two problems. The detailed contents thereof will be explained with reference to FIG. 3.

Generally, in a video input signal 11, a retrace line interval used for the horizontal drive and the vertical drive of a screen in a CRT is included. However, in the image display device of displaying images by plural display elements arranged in matrix (for example, a field emission type image display device using SCE elements, a liquid crystal display device, a plasma display device), the retrace line interval is not required. Therefore, the video input signal 11 is initially converted into a display video signal 12 not including the retrace line interval by a digital process.

The control circuit 4 controls the scan drivers 5 and the modulation drivers 6 on the basis of the display video signal 12. At this time, when the shift register 9 is transmitting (shifting) shift data 13 used for scanning the n-th field (n is a positive integer), that is, before the termination of transmitting the shift data 13 from the most upper register to the lowest register, the control circuit 4 gives shift data 14 used for scanning the (n+1)-th field to the shift register 9. More preferably, the control circuit 4 gives the shift data 14 to the shift register 9 with such a timing of transmitting the shift data 14 to a register 21 which selects a head scan wiring 2 in the (n+1)-th field after the termination of transmitting the shift data 14 to the register 21 which selects a final scan wiring 2 in the n-th field. For example, in a case that the 36 surplus registers 9A exist, an input timing of the shift data 14 used for scanning the (n+1)-th field can be set to 36 clocks before from a start position of the display video signal 12 corresponding to the scan of the (n+1)-th field. In this case, since the control unit 4 controls that the shift data is to be transmitted to the register which selects the head scan wiring in the (n+1)-th field synchronizing with the next clock after the termination of transmitting the shift data to the register which selects the final scan wiring in the n-th field, a period of the blank shift can be seemingly disappeared.

In this manner, by previously executing the blank shift of the shift data used for scanning the next field, a period of the blank shift can be seemingly decreased. As a result, in a case that a driving method of the display device is a pulse width modulation method of modulating the pulse width of a modulation signal to be applied to the modulation wirings in accordance with image data, a horizontal scanning period being a display period (a time required for emitting the light from elements) can be kept to the maximum, the luminance of the display panel can be increased and the dynamic range in the gradation reproduction can be enlarged.

Further, since the shift register has not to be operated with the high speed as conventional and the shift register operated with the low speed can be used, the IC can be easily designed and the costs can be reduced.

If the shift data is input with the above timing, since the one of the two shift data always exists in the surplus registers 9A, the two scan wirings 2 are not to be driven at the same time. Therefore, a problem of displaying double images does not occur, and a problem of increasing the calorific value due to the increase of electricity consumption of the IC does not occur.

In the present embodiment, the succeeding shift data was input with such a timing of starting the scan of the (n+1)-th field immediately after terminating the scan of the n-th field. However, an input timing is not limited to the above timing. That is, the succeeding shift data is input before terminating the scan of the n-th field, and if the blank shift corresponding to at least one or more clocks is executed, since a period of the blank shift is shorten for that worth, an operational effect according to the above embodiment can be taken.

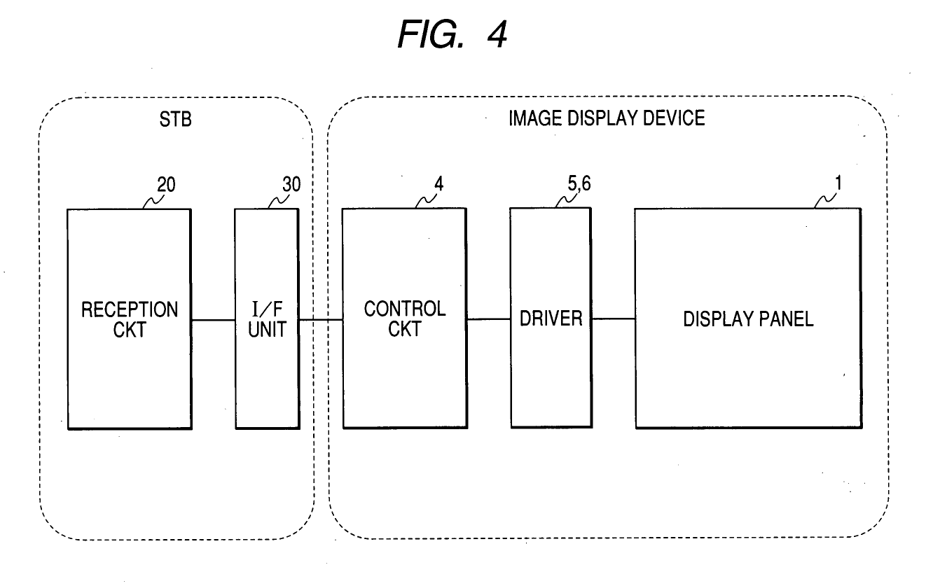

FIG. 4 is a block diagram of a television device having the above image display device. A reception circuit 20 is composed of a tuner, a decoder and the like. The reception circuit 20 receives the satellite broadcasting, television signals such as terrestrial waves, the data broadcasting through a network and the like and outputs decoded video data to an I/F (interface) unit 30. The I/F unit 30 converts video data into data of a display format of the image display device and outputs image data to the image display device. The image display device has the display panel 1, the drivers 5 and 6 and the control circuit 4. The control circuit 4 executes an image process such as a correction process or the like suitable for the display panel 1 for the input image data and outputs the image data and various control signals to the drivers 5 and 6. The drivers 5 and 6 output drive signals to the display panel 1 on the basis of the input image data. Accordingly, the television video is displayed on the display panel 1.

The reception circuit 20 and the I/F unit 30 may be held in another cage other than a cage of the image display device as an STB (set top box) or may be held in the cage of the image display device.

According to the present invention, the decrease of a display period due to the blank shift executed in the shift register can be avoided, and the luminance of the display panel is improved. Further, since the shift register has not to be operated with the high speed, the difficulty in design of the IC is decreased.

This application claims priority from Japanese Patent Application No. 2004-191823 filed Jun. 29, 2004, which is hereby incorporated by reference herein.

1. A display device which is equipped with a display panel having plural scanning wirings, plural modulation wirings and plural matrix-arranged display elements, and a driving device for driving the display panel, wherein
said driving device comprises a scanning driver adapted to output selection signals with sequential addressing to each scanning line of said scanning wirings, and a controller adapted to control said scanning driver,
said scanning driver comprises a shift register adapted to sequentially transfer shift data input from said controller to registers,
the selection signals are output based on the shift data, and
before transfer of first shift data by which said shift register scans a first field ends (218), said controller controls to input second shift data by which said shift register scans a second field subsequent to the first field to said shift register (211).

2. A display device which is equipped with a display panel having plural scanning wirings, plural modulation wirings and plural matrix-arranged display elements, and a driving device for driving the display panel, wherein
said driving device comprises a scanning driver adapted to output selection signals with sequential addressing to each scanning line of said scanning wirings, and a controller adapted to control said scanning driver,
said scanning driver comprises a shift register adapted to sequentially transfer shift data input from said controller to registers,
the selection signals are output based on the shift data,
before transfer of first shift data by which said shift register scans a first field ends (218), said controller controls to transfer second shift data by which said shift register scans a second field subsequent to the first field to said shift register (211), and
after the transfer of the first shift data to the register (215) of selecting the last scanning wiring in the first field ended, said controller controls to transfer the second shift data to the register (214) of selecting the headmost scanning wiring in the second field.

3. A display device according to claim 2, wherein said controller controls to transfer the second shift data to the register (214) of selecting the headmost scanning wiring in the second field, in synchronism with a shift clock subsequent to the end of the transfer of the first shift data to the register (215) of selecting the last scanning wiring in the first field.

4. A display device according to claim 2, wherein said scanning driver has an output line which is not connected to said scanning wirings.

5. A television device comprising:
a receiver adapted to receive a television signal; and
a display device, adapted to display the received television signal, which is equipped with a display panel having plural scanning wirings, plural modulation wirings and plural matrix-arranged display elements, and a driving device for driving the display panel, wherein
said driving device comprises a scanning driver adapted to output selection signals with sequential addressing to each scanning line of said scanning wirings, and a controller adapted to control said scanning driver,
said scanning driver comprises a shift register adapted to sequentially transfer shift data input from said controller to registers,
the selection signals are output based on the shift data,
before transfer of first shift data by which said shift register scans a first field ends (218), said controller controls to transfer second shift data by which said shift register scans a second field subsequent to the first field to said shift register (211),
after the transfer of the first shift data to the register (215) of selecting the last scanning wiring in the first field ended, said controller controls to transfer the second shift data to the register (214) of selecting the headmost scanning wiring in the second field, and
said scanning driver has an output line which is not connected to said scanning wirings.

6. A control method for a shift register which inputs shift data from a controller and sequentially transfers the input shift data to m (m is a positive number) registers, wherein
on the premise that a scanning period while the shift data are sequentially transferred to first to m-th registers is set as one field, before the transfer of first shift data by which the shift register scans a first field ends, it causes the controller to control to input second shift data by which the shift register scans a second field subsequent to the first field to the shift register.

7. A display device according to claim 2, wherein said driving device comprises a modulation driver adapted to output to said modulation wirings a modulation signal by which a pulse width is modulated based on a video signal.
